(19) United States
(12) Patent Application Publication
(10) Pub. No.: US 2011/0259941 A1
(43) Pub. Date: Oct. 27, 2011

(54) APPARATUS FOR MONITORING BONDING SURFACE BOUNCING, WIRE BONDING APPARATUS HAVING THE SAME AND METHOD FOR MONITORING BONDING SURFACE BOUNCING

(76) Inventor: Soo Seong KIM, Hwaseong (KR)

(21) Appl. No.: 13/091,832

(22) Filed: Apr. 21, 2011

(30) Foreign Application Priority Data
Apr. 27, 2010 (KR) 10-2010-0038930

(51) Int. Cl. B23K 31/12

(52) U.S. Cl. 228/102; 228/56.5; 228/9; 228/104

(57) ABSTRACT

There are provided an apparatus for monitoring bonding surface bouncing, a wire bonding apparatus having the same, and a method for monitoring bonding surface bouncing. According to an aspect of the present invention, the apparatus for monitoring bonding surface bouncing includes a sensor measuring a capillary height in real time during bonding and a bouncing detector extracting a change rate of a capillary height from the capillary height measured in real time during a bonding performing period and detecting of whether bonding surface bouncing is present by comparing the extracted change rate with a set reference change rate.

### CROSS-REFERENCE TO RELATED APPLICATIONS

This application claims the priority of Korean Patent Application No. 10-2010-0038930 filed on Apr. 27, 2010, in the Korean Intellectual Property Office, the disclosure of which is incorporated herein by reference.

### BACKGROUND OF THE INVENTION

1. Field of the Invention

The present invention relates to an apparatus for monitoring bonding surface bouncing, a wire bonding apparatus having the same, a method for monitoring bonding surface bouncing, and a recording medium recorded with a method for monitoring bonding surface bouncing in real time readable with electronic devices.

2. Description of the Related Art

A process for manufacturing a semiconductor is classified into a fabrication (FAB) process, an electronic die sorting (EDS) process, and an assembly process. In this case, the FAB process is divided into a diffusion process, a photographing process, an etching process, and a thin film process, wherein the EDS process is a process of differentiating whether or not chip defects are present through an electrical characteristic test for each chip configuring a wafer subjected to the FAB process and the assembly process is a process that individually separates good quality chips, according to the EDS process, to form them into a package state so that the chips have electrical and physical characteristics, thereby protecting the chips from external mechanical/physical/chemical impacts and mounting them on a printed circuit board (PCB).

The assembly process individually separates the chips on the wafer and bonds the separated chips to a lead frame. Next, for an electrical connection between a lead of a lead frame and a pad of a chip serving as a gate of a chip circuit terminal, a wire bonding process for connecting the chips with a capillary using a high-purity gold wire is performed.

In the wire bonding process, bouncing may occur since a semiconductor chip (or die) or a lead frame is not fixed. The bouncing of the semiconductor chip (or die) or the lead frame implies a state in which the semiconductor chip or the lead frame float on a heat block.

As such, the bouncing of the semiconductor chip or the lead frame leads to the instability of a bonding level, the instability of interaction of a lead frame or a pad or a bonding parameter in facilities, which are factors causing a variety of types of defects.

Owing to the above-mentioned problem, the assembly process or the packaging process help to improve the designs of the heater block and the window clamp fixing the lead frame or the pad and help to develop technology for the precise manufacturing thereof and use a method of confirming the bouncing by pressing the lead frame or the pad with tweezers at the time of replacing a model during a manufacturing process or by monitoring a vacuum pressure of the heater block in the case of a circuit board to detect the bouncing.

However, the quality of the lead frame is deteriorated due to the bouncing when the clamping state of the metal lead frame is incomplete or the vacuum pressure of the heater block cannot be used.

### SUMMARY OF THE INVENTION

An aspect of the present invention provides an apparatus for monitoring bonding surface bouncing that automatically monitors whether there is bonding surface bouncing in real time to detect the generation of bouncing and inform a manufacturer of it, a wire bonding apparatus having the same, and a method for monitoring bounding surface bouncing.

According to an aspect of the present invention, there is provided an apparatus for monitoring bonding surface bouncing, including: a sensor measuring a capillary height in real time during bonding; and a bouncing detector extracting a change rate of a capillary height from the capillary height measured in real time during a bonding performing period and detecting of whether bonding surface bouncing is present by comparing the extracted change rate with a set reference change rate.

The reference change rate may be reset before the bonding.

The apparatus for monitoring bonding surface bouncing may further include a display unit detecting bonding surface bouncing in the bouncing detector to display whether bonding surface bouncing is present to the outside.

The display unit may include a lamp or an alarm device.

The sensor may be an encoder measuring a Z-axis height of the capillary.

According to another aspect of the present invention, there is provided an apparatus for monitoring bonding surface bouncing, including: a sensor measuring a force feedback value transferred to a bonding surface from a capillary during bonding in real time; and a bouncing detector extracting a change rate of a feedback value measured in real time during a bonding performing period and detecting of whether bonding surface bouncing is present by comparing the extracted change rate with a set reference change rate.

The reference change rate may be reset before the bonding.

The apparatus for monitoring bonding surface bouncing may further include, when the generation of bonding surface bouncing is detected in the bouncing detector, a display unit displaying it to the outside.

The sensor may be a piezoelectric sensor.

According to another aspect of the present invention, there is provided an apparatus for monitoring bonding surface bouncing, including: a first sensor measuring a capillary height in real time during bonding; a second sensor measuring a force feedback value transferred to a bonding surface from the capillary in real time during the bonding; and a bouncing detector extracting a change rate of a capillary height from the capillary height measured in real time during a bonding performing period and detecting of whether bonding surface bouncing is present by comparing the extracted change rate with a set first reference change rate or extracting a change rate of a feedback value from the feedback value measured in real time during a bonding performing period and detecting of whether bonding surface bouncing is present by comparing the extracted change rate with a set second reference change rate.

The first reference change rate and the second reference change rate may be reset before the bonding.

The apparatus for monitoring bonding surface bouncing may further include, when the bonding surface bouncing is detected in the bouncing detector, a display unit displaying it to the outside.

The first sensor may be an encoder measuring a Z-axis height of the capillary and the second sensor may be a piezoelectric sensor.

According another aspect of the present invention, there is provided a wire bonding apparatus, including; an apparatus for monitoring bonding surface bouncing including a sensor disposed on an upper portion of a bond head and measuring a capillary height in real time during bonding, and a bonding surface bouncing detector extracting a change rate of a capillary height from the capillary height measured in real time during a bonding performing period and detecting of whether bonding surface bouncing is present by comparing the extracted change rate with a set reference change rate; and when bonding surface bouncing is detected, a display unit displaying it to the outside.

The reference change rate may be reset before the bonding.

The wire bonding apparatus may further include a controller performing controlling to stop the wire bonding when bonding surface bouncing is detected.

According another aspect of the present invention, there is provided a wire bonding apparatus, including: an apparatus for monitoring bonding surface bouncing including a sensor measuring a force feedback value transferred to a bonding surface from a capillary in real time during bonding and a bouncing detector extracting a change rate of the feedback value measured in real time during a bonding performing period and detecting of whether bonding surface bouncing is present by comparing the extracted change rate with a set reference change rate; and when bonding surface bouncing is detected, a display unit displaying it to the outside.

The reference change rate may be reset before the bonding.

The wire bonding apparatus may further include a controller performing controlling to stop the wire bonding when bonding surface bouncing is detected.

According to another aspect of the present invention, there is provided a wire bonding apparatus, including: an apparatus for monitoring bonding surface bouncing including a first sensor measuring a capillary height in real time during bonding, a second sensor measuring a force feedback value transferred to a bonding surface from the capillary in real time during the bonding, and a bouncing detector extracting a change rate of a capillary height from the capillary height measured in real time during a bonding performing period and detecting of whether bonding surface bouncing is present by comparing the extracted change rate with a set first reference change rate or extracting a change rate of a feedback value from the feedback value measured in real time during a bonding performing period and detecting of whether bonding surface bouncing is present by comparing the extracted change rate with a set second reference change rate; and when bonding surface bouncing is detected, a display unit displaying it to the outside.

The first reference change rate and the second reference change rate may be reset before the bonding.

The wire bonding apparatus may further include a controller performing controlling to stop the wire bonding when bonding surface bouncing is detected.

According to another aspect of the present invention, there is provided a method for monitoring bonding surface bouncing, including: measuring a capillary height in real time during wire bonding; extracting the capillary height from a bonding start time when the wire is bonded to a bonding surface by lowering the capillary to the bonding surface to pressurization ending time when the bonding surface pressurization of the capillary ends, among the measured capillary heights; calculating a change rate of the capillary height from the bonding start time to pressurization ending time; and detecting of whether bonding surface bouncing is present by comparing the change rate of the capillary height with a set reference change rate.

The reference change rate maybe set in plural, wherein one reference change rate may be previously selected before the bonding starts.

The method for monitoring bonding surface bouncing may further include, when bonding surface bouncing is detected, displaying the bouncing detection to the outside.

The reference change rate may be reset before the bonding starts.

The method for monitoring bonding surface bouncing may further include, when bonding surface bouncing is detected, stopping the wire bonding.

According to another aspect of the present invention, there is provided a method for monitoring bonding surface bouncing, including: measuring a force feedback value transferred to a bonding surface from a capillary during wire bonding in real time; extracting a feedback value from a bonding start time when the wire is bonded to a bonding surface by lowering the capillary to the bonding surface to pressurization ending time when the bonding surface pressurization of the capillary ends, among the measured feedback values; calculating a change rate of the feedback value from the bonding start time to pressurization ending time; and detecting of whether bonding surface bouncing is present by comparing the change rate of the feedback value with a set reference change rate.

The reference change rate may be set in plural, wherein one reference change rate may be previously selected before the bonding starts.

The method for monitoring bonding surface bouncing may further include, when bonding surface bouncing is detected, displaying the bouncing detection to the outside.

The reference change rate may be reset before the bonding starts.

The method for monitoring bonding surface bouncing may further include, when bonding surface bouncing is detected, stopping the wire bonding.

According to another aspect of the present invention, there is provided a method for monitoring bonding surface bouncing, including: measuring a capillary height and a force feedback value transferred to a bonding surface from a capillary during wire bonding in real time; extracting a capillary height and a feedback value, respectively, from a bonding start time when the wire is bonded to a bonding surface by lowering the capillary to the bonding surface to pressurization ending time when the bonding surface pressurization of the capillary ends, among the measured capillary heights; calculating a change rate of the capillary height and the feedback value, respectively, from the bonding start time to pressurization ending time; and detecting of whether bonding surface bouncing is present by comparing the change rate of the capillary height with a set first reference change rate and the change rate of the feedback value with a set second reference change rate.

The method for monitoring bonding surface bouncing may further include resetting the first reference change rate and the second reference change rate before the wire bonding starts.

The detecting of whether bonding surface bouncing is present by comparing the change rate of the capillary height with a set first reference change rate and the change rate of the feedback value with a set second reference change rate may determine that bonding surface bouncing is present if it corresponds to any one of the cases in which the change rate of the extracted capillary height exceeds the set first reference change rate or the change rate of the feedback value exceeds the set second reference change rate.

The method for monitoring bonding surface bouncing may further include, when bonding surface bouncing is detected, displaying the bounding detection by a lamp or an alarm.

According to another aspect of the present invention, there is provided a recording medium recorded with a program monitoring bonding surface bouncing in real time and readable with electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an exemplary embodiment of a bond head of a wire bonding apparatus including an apparatus for monitoring bonding surface bouncing according to an aspect of the present invention;

FIG. 2 is a perspective view showing an exemplary embodiment of a bond head of a wire bonding apparatus including an apparatus for monitoring bonding surface bouncing according to another aspect of the present invention;

FIG. 3 is a perspective view showing an exemplary embodiment of a bond head of a wire bonding apparatus including an apparatus for monitoring bonding surface bouncing according to another aspect of the present invention;

FIG. 4 is a side view schematically showing another exemplary embodiment of a wire bonding apparatus including an apparatus for monitoring bonding surface bouncing according to another aspect the present invention;

FIG. 5 is a flow chart for explaining an exemplary embodiment of a method for monitoring bonding surface bouncing according to another aspect the present invention;

FIG. 6 is a flow chart for explaining another exemplary embodiment of a method for monitoring bonding surface bouncing according to another aspect of the present invention;

FIG. 7 is a flow chart for explaining another exemplary embodiment of a method for monitoring bonding surface bouncing according to another aspect of the present invention; and

FIGS. 8A and 8B are waveform diagrams for explaining another exemplary embodiment of a method for monitoring bonding surface bouncing according to another aspect of the present invention.

### DETAILED DESCRIPTION OF THE PREFERRED EMBODIMENT

Although the present invention can be modified variously and have several embodiments, the exemplary embodiments are illustrated in the accompanying drawings and will be described in detail in the detailed description. However, the present invention is not limited to the specific embodiments and should be construed as including all the changes, equivalents, and substitutions included in the spirit and scope of the present invention.

An apparatus for monitoring bonding surface bouncing, a wire bonding apparatus having the same, and a method for monitoring bonding surface bouncing according to the present invention will be described in detail with reference to the accompanying drawings. Like components will be denoted by like reference numerals throughout the accompanying drawings and a description of the repeated components will be omitted.

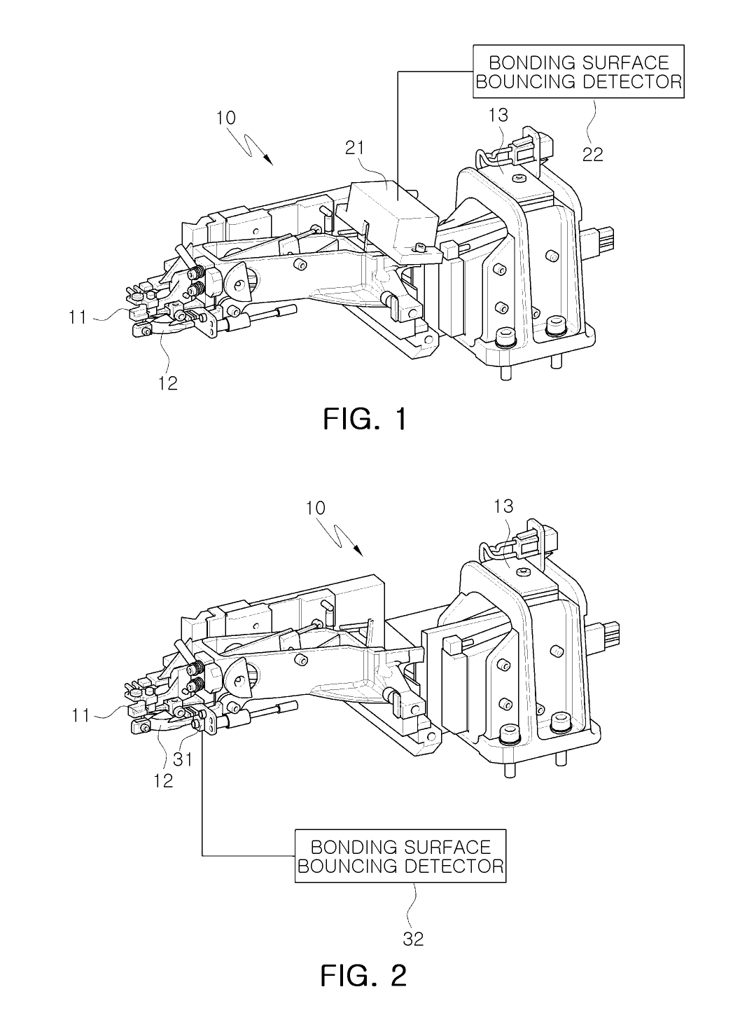

FIG. 1 is a perspective view showing an exemplary embodiment of a bond head 10 of a wire bonding apparatus including an apparatus for monitoring bonding surface bouncing according to an aspect of the present invention.

According to the exemplary embodiment, as shown in FIG. 1, a wire bonding apparatus includes an apparatus for monitoring bonding surface bouncing that includes a sensor 21 disposed on the upper portion of the bond head 10 of the wire bonding apparatus to measure a capillary height in real time during bonding and a bouncing detector 22 extracting a change rate of the capillary height from the capillary height measured in real time during the bonding performing period and detecting of whether bonding surface bouncing is present by comparing the extracted change rate with a reference change rate and when the bonding surface bouncing is detected, a display unit (not shows) displaying it to the outside.

The wire bonding apparatus includes the apparatus for monitoring bonding surface bouncing detecting bonding surface bouncing according to an aspect of the present invention, the display unit displaying the detected bouncing, a controller performing controlling to stop the wire bonding when bonding surface bouncing is detected, and components included in a general wire bonding apparatus.

First, components related to the exemplary embodiment among components of the general wire bonding apparatus will be described.

The wire bonding apparatus includes a transducer 12 applying an ultrasonic wave to the bond head 10 through a capillary, a wire clamp 11 supporting a wire penetrating through the capillary and applying tension to the wire, and a motor 13 driving a bond arm.

The wire clamp 11 may be disposed on the upper portion of the transducer 12, a first end of the wire clamp 11 may be disposed to be spaced apart from the transducer 12, and a second end of the wire clamp 11 may be disposed on the bond arm.

The motor 13 may vertically drive the bond arm so that the capillary approaches the bonding surfaces or moves away from the bonding surface.

The apparatus for monitoring bonding surface bouncing according to an aspect of the present invention is configured to include the sensor 21 and the bouncing detector 22 and the sensor 21, and the bouncing detector 22 or the bouncing detector 22 and the controller (not shown) of the wire bonding apparatus may be integrally formed.

The sensor 21 may measure the capillary height in real time when the wire bonding starts and store the measurement. The wire bonding apparatus may drive a z-axis motor 13 to lowering the capillary to the bonding surfaces and perform the wire bonding by a method of applying the pressure to be bonded to the bonding surfaces and lifting the capillary when the bonding is complete.

The sensor 21 may be configured to include a digital position sensor, i.e., an encoder measuring a rotation angle position and linear displacement in order to measure the z-axis height of the capillary.

The bouncing detector 22 may use data of the capillary height measured in real time during the wire bonding to calculate the change rate of the capillary height during the bonding performing period and may detect whether bonding surface bouncing is present by comparing the calculated change rate with a reference change rate.

The bonding performing period may be defined as a period from a bonding time at which the wire penetrating through the capillary is bonded to the bonding surfaces to a pressurization ending time at which pressurization ends.

The bouncing detector 22 may calculate an average change rate of the capillary height during part of or all of the bonding performing period, detect whether bonding surface bouncing is present by comparing the calculated average change rate with the reference change rate, divide the bonding performing period into a plurality of periods and compare the average value of the change rate of the capillary height measured in each period with the reference change rate to detect whether bonding surface bouncing is present, and compare the capillary height of the sampled time in several bonding periods with the reference change rate to detect whether bonding surface bouncing is present.

The reference change rate implies the average change rate of the capillary height during part of or all of the bonding performing period when bonding surface bouncing is absent, the average value of the change rate of the capillary height measured in each period by dividing the bonding performing period into a plurality of periods, or the change rate of the sampled capillary height capable of being determined as a case in which bonding surface bouncing is absent.

Since the reference change rate may be previously set or reset before the wire bonding starts, it may reflect various factors according to facility characteristics and working environments.

The display unit (not shown) may serve to inform a manufacturer when bonding surface bouncing is detected. The display unit may be configured to include a lamp or an alarm device (for example, buzzer, or the like) and be attached to the outside of the wire bonding apparatus.

The controller (not shown) may perform controlling to stop the wire bonding working when bonding surface bouncing is detected.

FIG. 2 is a perspective view showing a bond head 10 of a wire bonding apparatus including an apparatus for monitoring bonding surface bouncing according to another aspect of the present invention.

According to the exemplary embodiment, as shown in FIG. 2, a wire bonding apparatus includes an apparatus for monitoring bonding surface bouncing that includes a sensor 31 disposed on the upper portion of the bond head 10 of the wire bonding apparatus to measure a force feedback value transferred to the bonding surface from the capillary in real time during the bonding and a bouncing detector 32 extracting a change rate of the feedback value from the feedback value measured in real time during the bonding performing period and detecting of whether there is bonding surface bouncing is present by comparing the extracted change rate of the feedback value with a set reference change rate and when bonding surface bouncing is detected, a display unit (not shown) displaying it to the outside.

According to the exemplary embodiment, the wire bonding apparatus will be described based on the difference in a case in which the apparatus for monitoring bonding surface bouncing according to an aspect of the present invention (see FIG. 1) as described above is replaced with an apparatus for monitoring bonding surface bouncing according to another aspect of the present invention.

The apparatus for monitoring bonding surface bouncing according to another aspect of the present invention is configured to include the sensor 31 and the bouncing detector 32 and the sensor 31 and the bouncing detector 32 or the bouncing detector 32 and the controller (not shown) of the wire bonding apparatus may be integrally formed.

The sensor 31 may measure the force (bonding force) feedback value transferred to the bonding surfaces from the capillary during the bonding performing period in real time and store the measurement. The bonding force is generated when the lowered capillary pressurizes the bonding surface and may be changed from the time when the capillary pressurizes to the bonding surface to the time when pressurization ends.

The sensor 31 may be disposed in an area connected with the transducer 12 of the bond head and may be configured to include a piezoelectric sensor measuring the bonding force or a change in the bonding force during the bonding performing period.

The bouncing detector 32 may use the force feedback value measured in real time during the wire bonding process to calculate the change rate of the force feedback value during the bonding performing period and may detect whether bonding surface bouncing is present by comparing the calculated change rate with the reference change rate.

The bonding performing period may be defined as a period from the bonding start time of pressurizing the capillary to the bonding surfaces to pressurization ending time of ending the pressurization.

The bouncing detector 32 may calculate an average change rate of the force feedback value during a part or all of the bonding performing period, detect whether bonding surface bouncing is present by comparing the calculated average change rate with the reference change rate, divide the bonding performing period into a plurality of periods and compare the average value of the change rate of the force feedback value measured in each period with the reference change rate to detect whether bonding surface bouncing is present, and compare the force feedback value of the sampled time in several bonding periods with the reference feedback value to detect whether bonding surface bouncing is present.

The reference change rate implies the difference between the average change rate of the force feedback value during a part or all of the bonding performing period when bonding surface bouncing is absent, the average value of the change rate of the force feedback value measured in each period by dividing the bonding performing period into a plurality of periods, or the sampled feedback value capable of being determined as a case in which the bonding surface bouncing is absent.

Since the reference change rate may be previously set or reset before the wire bonding starts, it may reflect various factors according to facility characteristics and working environments.

The display unit (not shown) may serve to inform a manufacturer when bonding surface bouncing is detected. The display unit may be configured to include a lamp or an alarm device (for example, buzzer, or the like) and be attached to the outside of the wire bonding apparatus.

The controller (not shown) may perform controlling to stop the wire bonding working when bonding surface bouncing is detected.

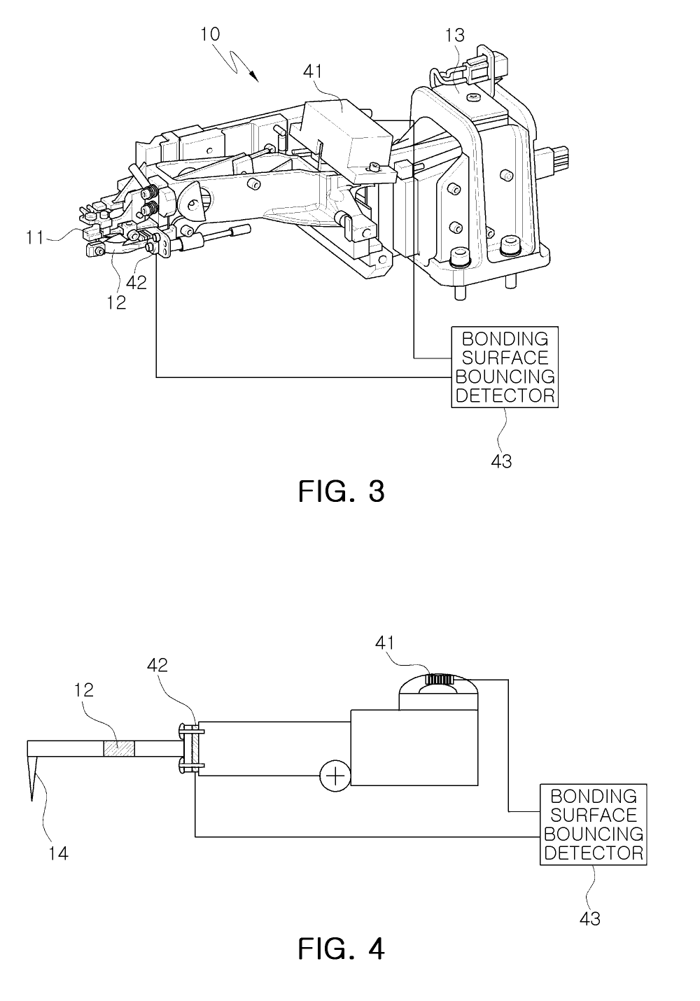

FIG. 3 is a perspective view showing an exemplary embodiment of a bond head 10 of a wire bonding apparatus including an apparatus for monitoring bonding surface bouncing according to another aspect of the present invention and FIG. 4 is a side view schematically showing another exemplary embodiment of a wire bonding apparatus including an apparatus for monitoring bonding surface bouncing according to another aspect the present invention.

According to the exemplary embodiment, as shown in FIG. 3, the wire bonding apparatus is an apparatus for monitoring bonding surface bouncing that includes a first sensor 41 disposed on the upper portion of the bond head 10 and measuring the capillary height in real time during the bonding, a second sensor 42 disposed on the upper portion of the bond head 10 of the wire bonding apparatus and measuring the force (bonding force) feedback value transferred from the capillary to the bonding surfaces in real time during the bonding, and a bouncing detector 43 extracting the change rate of the capillary height with the change rate of the feedback value from the capillary height and the feedback value measured in real time during the bonding performing period and comparing the extracted change rate with the first and second set reference change rates, respectively, to detect whether bonding surface bouncing is present and when the bonding surface bouncing is detected, a display unit (not shown) displaying it to the outside.

According to the exemplary embodiment, the wire bonding apparatus will be described based on the difference in a case in which the apparatus for monitoring bonding surface bouncing according to another aspect of the present invention (see FIG. 2) as described above is replaced with an apparatus for monitoring bonding surface bouncing according to another aspect of the present invention.

The apparatus for monitoring bonding bouncing surface according to another aspect of the present invention is configured to include the first sensor 41, the second sensor 42, and the bouncing detector 43. The bouncing detector 43 may be integrally formed with the controller (not shown) of the wire bonding apparatus.

The first sensor 41 measures the capillary height in real time when the wire bonding starts and stores the measurement and the second sensor 42 may measure the force (bonding force) feedback value transferred to the bonding surfaces from the capillary in real time during the bonding performing period and store the measurement.

The first sensor 41 may be configured to include the digital position sensor, i.e., the encoder measuring the rotation angle position and the linear displacement in order to measure the z-axis height of the capillary and the second sensor 42 may be configured to include the piezoelectric sensor that is disposed in the area connected to the transducer 12 of the bond head and measures the bonding force or the change in the bonding force during the bonding performing period.

The bouncing detector 43 may use the capillary height and the force feedback measured in real time during the wire bonding process to calculate the change rate of the capillary height during the bonding performing period and may detect whether bonding surface bouncing is present by comparing the calculated change rate with the first and second reference change rates.

The bonding performing period may be defined as a period from a bonding time at which the wire penetrating through the capillary is bonded to the bonding surfaces to a pressurization ending time at which pressurization ends.

The bouncing detector 43 may calculate the average change rate of the capillary height and the force feedback value during a part or all of the bonding performing period and detect whether bonding surface bouncing is present by comparing the calculated average change rate with the first and second reference change rates.

Further, the bouncing detector 43 divides the bonding performing period in a plurality of periods and compares the average value of the capillary height and the change rate in the force feedback value measured in each period with the first and second reference change rates, respectively, to detect whether bonding surface bouncing is present.

Further, the bouncing detector 43 may compare the capillary height and the force feedback value of the sampled time during several bonding performing periods with the first and second reference change rates, respectively, to detect whether bonding surface bouncing is present.

In addition to the method of detecting of whether bonding surface bouncing is present, bonding surface bouncing may be detected by representing the capillary height and the force feedback value as a waveform and comparing the waveform with a waveform in a case in which bonding surface bouncing is absent.

The first reference change rate implies the average change rate of the capillary height during part of or all of the bonding performing period when the bonding surface bouncing is absent, the average value of the change rate of the capillary height measured in each period by dividing the bonding performing period into a plurality of periods, or the change rate of the sampled capillary height capable of being determined as a case in which the bonding surface bouncing is absent.

The second reference change rate implies the average change rate of the force feedback value during a part or all of the bonding performing period when the bonding surface bouncing is absent, the average value of the change rate of the force feedback value measured in each period by dividing the bonding performing period into a plurality of periods, or the difference between the sampled feedback values capable of being determined as a case in which bonding surface bouncing is absent.

Since the first and second reference change rates may be previously set or reset before the bonding starts, it may reflect various factors according to facility characteristics and working environments.

The first and second reference change rates may be set in plural according to the difference between the capillary height and the force feedback value in the case in which bonding surface bouncing is absent and the display unit may be represented by the bouncing alarm process and the bouncing detecting process, or the like, according to the difference between the measured value and the reference change rate.

The bouncing detector 43 may detect that the bonding surface bouncing is present if it corresponds to any one of the cases in which the change rate of the extracted capillary height exceeds the first reference change rate or the change rate of the feedback value of the extracted bonding force exceeds the set second reference change rate.

The second sensor 42 of the wire bonding apparatus including the apparatus for monitoring bonding surface bouncing according to another aspect of the present invention may be disposed in a location in which the transducer 12 and the bond arm are connected with each other.

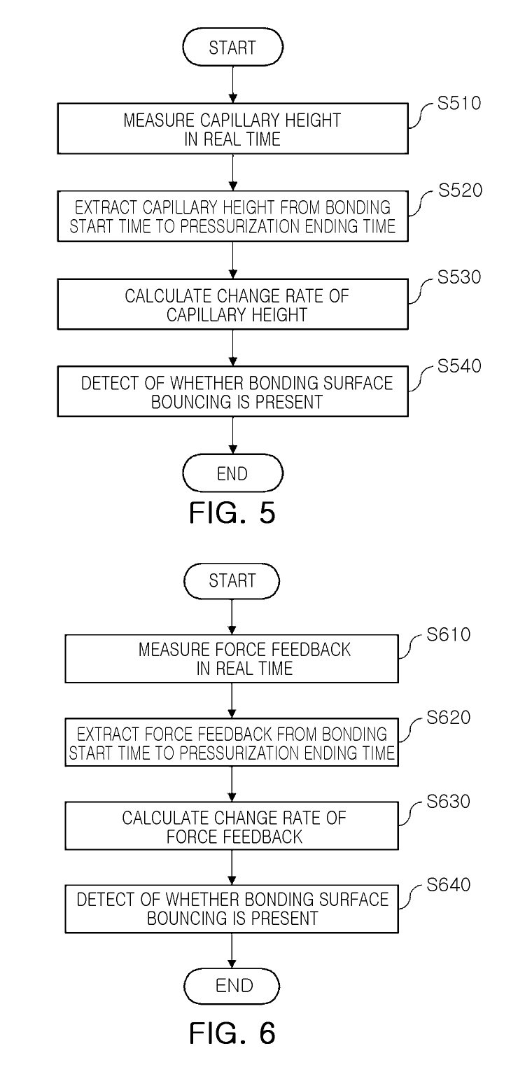

FIG. 5 is a flow chart for explaining an exemplary embodiment of a method for monitoring bonding surface bouncing according to another aspect the present invention.

According to the exemplary embodiment, the method for monitoring bonding surface bouncing may measure the capillary height in real time during the wire bonding (S510), extract the capillary height from the bonding start time to pressurization ending time (S520), calculate the change rate of the capillary height in the extracted period (S630), and detect whether bonding surface bouncing is present by comparing the calculated change rate with the reference change rate (S540).

The measurement of the capillary height (S510) may be executed by using the digital position sensor, i.e., the encoder measuring the rotation angle position and linear displacement and may measure the capillary height by using various sensors.

The sensor measuring the capillary height may be attached to the wire bonding apparatus and may be disposed on the upper portion of the bond head of the wire bonding apparatus capable of easily sensing the capillary position.

At the extraction of the capillary height (S520), among the capillary height measured in real time, the capillary height in a period (bonding performing period) from the bonding start time when the wire is bonded to the bonding surface by lowering the capillary to the bonding surface to pressurization ending time when bonding surface pressurization of the capillary ends, the capillary height in the specific period or the sampled time among the bonding performing period may be extracted.

The calculation of the change rate of the extracted capillary height (S530) may be executed by the difference between the average change rate between the capillary height of the bonding start time and the capillary height of the pressurization ending time, the average change rate of the specific period among the bonding performing period, and the average value of the change rate of the capillary height or the capillary height of the sampled time in each period by dividing the bonding performing period into the plurality of periods.

Next, the method for monitoring bonding surface bouncing may detect that the bonding surface bouncing occurs, when the change rate of the calculated capillary height exceeds the reference change rate by comparing the change rate of the calculated capillary height with the reference change rate (S540).

The reference change rate implies the average change rate of the capillary height during a part or all of the bonding performing period when the bonding surface bouncing is absent, the average value of the change rate of the capillary height measured in each period by dividing the bonding performing period into a plurality of periods, or the change rate of the sampled capillary height capable of being determined as a case in which bonding surface bouncing is absent.

The reference change rate may be set in plural and be previously selected before the wire bonding starts and when the wire bonding restarts, may be reset before the wire bonding starts.

When bonding surface bouncing is detected, the bouncing detection may be displayed to the outside and the wire bonding may stop.

FIG. 6 is a flow chart for explaining another exemplary embodiment of a method for monitoring bonding surface bouncing according to another aspect of the present invention.

According to the exemplary embodiment, the method for monitoring bonding surface bouncing may measure the force feedback value in real time (S610), extract the force feedback value from the bonding start time to pressurization ending time (S620), calculate the change rate of the feedback value in the extracted period (S630), and detect whether bonding surface bouncing is present by comparing the calculated change rate with the reference change rate (S640).

The measurement of the force feedback value (S610) during the wiring bonding may be executed by the piezoelectric sensor that is disposed in an area of the bond head connected to the transducer and the bonding force or the change in the bonding force.

Since the bonding force may be generated when the lowered capillary pressurizes the bonding surface and the bonding force may be changed from the time when the capillary pressurizes the bonding surface to the time when the pressurization ends, the method for monitoring bonding surface bouncing may detect whether bonding surface bouncing is present by using the change rate of the force feedback value.

At the extraction of the force feedback value (S620), the feedback value of the period from bonding start time to pressurization ending time (bonding performing period) among the feedback values measured in real time, the feedback value in the specific period among the bonding performing periods, or the feedback value of the sampled time among the bonding performing periods may be extracted.

The calculation of the change rate of the feedback value in the extracted period (S630) may be executed by the difference between the average change rate between the force feedback value of the bonding start time and the force feedback value of the pressurization ending time, the average change rate of the force feedback value in the specific period among the bonding performing period, and the average value of the change rate of the force feedback value or the force feedback value of the sampled time in each period by dividing the bonding performing period into the plurality of periods.

Next, the method for monitoring bonding surface bouncing may detect that bonding surface bouncing is present, when the change rate of the calculated capillary height exceeds the reference change rate by comparing the change rate of the calculated feedback value with the reference change rate (S640).

The reference change rate implies the average change rate of the force feedback value during a part or all of the bonding performing period when the bonding surface bouncing is absent, the average value of the change rate of the force feedback value measured in each period by dividing the bonding performing period into a plurality of periods, or the difference between the sampled feedback values capable of being determined as a case in which the bonding surface bouncing is absent.

The reference change rate may be set in plural and previously selected before the wire bonding starts and when the wire bonding restarts, may be reset before the wire bonding starts.

When the bonding surface bouncing is detected, the method for monitoring bonding surface bouncing may be displayed through the lamp or the alarm device (for example, a buzzer, etc.) and may perform controlling to stop the wire bonding process.

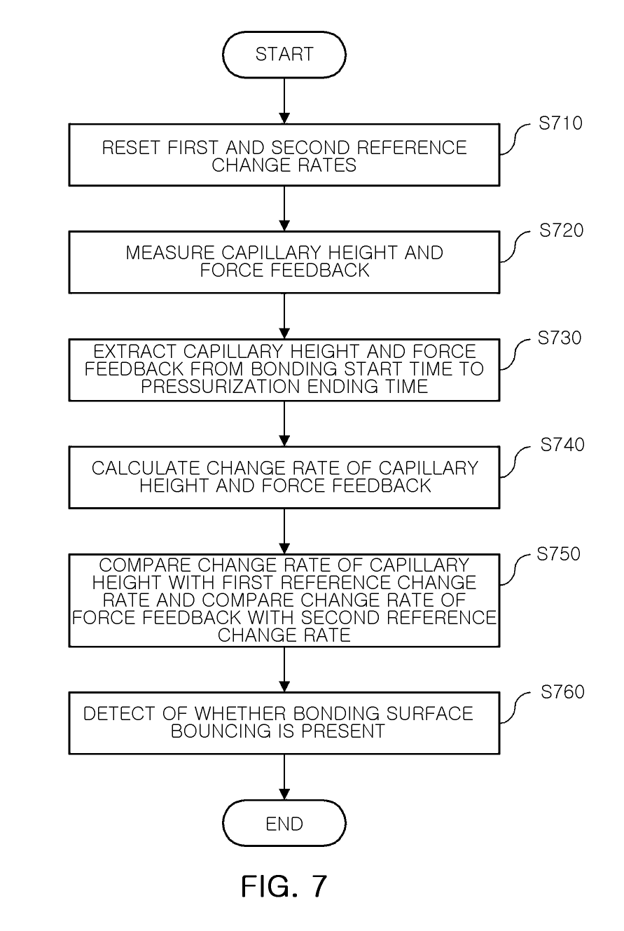

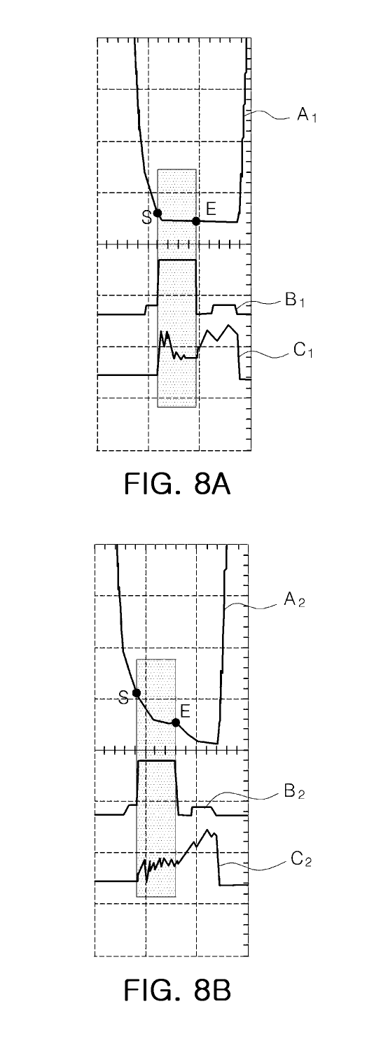

FIG. 7 is a flow chart for explaining another exemplary embodiment of a method for monitoring bonding surface bouncing according to another aspect of the present invention and FIGS. 8A and 8B are waveform diagrams for explaining another exemplary embodiment of a method for monitoring bonding surface bouncing according to another aspect of the present invention.

According to the exemplary embodiment of the present invention, the method for monitoring bonding surface bouncing may reset the first and second reference change rates before the wire bonding starts (S710), measure the capillary height and the force feedback value in real time (S720), extract the capillary height and the force feedback value from the bonding start time to pressurization ending time (S730), calculate the change rate of the capillary height and the feedback value in the extracted period (S740), and detect whether bonding surface bouncing is present by comparing the calculated change rate with the first and second reference change rates (S750).

According to the exemplary embodiment of the present invention, the measuring of the capillary height and the force feedback value in real time (S720), the extracting of the capillary height and the force feedback value from the bonding start time to pressurization ending time (S730), and the calculating of the change rate of the capillary height and the feedback value in the extracted period (S740) are the same as the foregoing description (see FIGS. 5 and 6) and therefore, only the differences therebetween will now be described.

The resetting of the first and second reference change rates (S710) before the wire bonding is to differently apply the bouncing generation reference according to the type of the working facilities or the working environment and each of the first and second reference change rates may be set to a plurality of values.

The detecting of whether bonding surface bouncing is present (S760) may determined by comparing the change rate of the calculated capillary height and the change rate of the force feedback value with the first and second reference change rates, respectively.

For example, the generation of the bonding surface bouncing may be detected when the change rate of the calculated capillary height exceeds the first reference change rate or the change rate of the calculated force feedback value exceeds the second reference change rate.

In addition, the method for monitoring bonding surface bouncing may detect that the bonding surface bouncing occurs only when the change rate of the calculated capillary height exceeds the first reference change rate and the change rate of the calculated force feedback value exceeds the second reference change rate.

In order to explain another exemplary embodiment of the method for monitoring bonding surface bouncing according to another aspect of the present invention, FIG. 8A shows a waveform obtained by monitoring a capillary height A₁, an applied ultrasonic size B₁, and a force feedback value C₁ in real time when bonding surface bouncing does not occur and FIG. 8B shows a waveform obtained by monitoring a capillary height A₂, an applied ultrasonic size B₂, and a force feedback value C₂ in real time when bonding surface bouncing occurs, wherein the capillary height, the ultrasonic size, and the force feedback value are represented by being standardized.

When bonding surface bouncing is absent, it can be confirmed that the change rate of the capillary height in the period from the bonding start time S to pressurization ending time E is very small, as shown in A₁ of FIG. 8A.

On the other hand, when bonding surface bouncing is present, it can be confirmed that the change rate of the capillary height in the period from the bonding start time S to pressurization ending time E is very large, as shown in A₂ of FIG. 8B.

When the bonding surface bouncing is absent, it can be confirmed via a waveform that the change rate of the force feedback value in the period from the bonding start time S to pressurization ending time E is stabilized, as shown in C₁ of FIG. 8A.

On the other hand, when bonding surface bouncing occurs, it can be confirmed that the change rate of the force feedback value in the period from the bonding start time S to pressurization ending time E is continuously changed, as shown in C₂ of FIG. 8B.

When bonding surface bouncing is absent, the first and second reference change rates may be set as values experimentally calculating the change rate of the capillary height and the feedback value.

According to another exemplary embodiment of the present invention, a recording medium may be recorded with a program monitoring bonding surface bouncing in real time and may be read with electronic devices.

The method for monitoring bonding surface bouncing in real time may be prepared in a computer program and codes and code segments configuring the program may be easily inferred by a computer programmer having skill in the art to which the present invention pertains.

The program relating to the method for monitoring bonding surface bouncing is stored in computer readable media readable by a computer and read and executed by a computer, thereby making it possible to monitor bonding surface bouncing in real time during the wire bonding.

As set forth above, the present invention can detect the state of bonding surface bouncing in real time, automatically monitor the state of bonding surface bouncing, add a monitoring function in bonding surface bouncing state by adding only the software function to the existing facilities, and apply it to various facilities by resetting the reference change rate.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for monitoring bonding surface bouncing, comprising:
a sensor measuring a capillary height in real time during bonding; and
a bouncing detector extracting a change rate of a capillary height from the capillary height measured in real time during a bonding performing period and detecting of whether bonding surface bouncing is present by comparing the extracted change rate with a set reference change rate.

2. The apparatus for monitoring bonding surface bouncing of claim 1, wherein the reference change rate is reset before the bonding.

3. The apparatus for monitoring bonding surface bouncing of claim 1, further comprising a display unit detecting bonding surface bouncing in the bouncing detector to display whether bonding surface bouncing is present to the outside.

4. The apparatus for monitoring bonding surface bouncing of claim 3, wherein the display unit includes a lamp or an alarm device.

5. The apparatus for monitoring bonding surface bouncing of claim 1, wherein the sensor is an encoder measuring a Z-axis height of the capillary.

6. An apparatus for monitoring bonding surface bouncing, comprising:
a sensor measuring a force feedback value transferred to a bonding surface from a capillary during bonding in real time; and
a bouncing detector extracting a change rate of a feedback value measured in real time during a bonding performing period and detecting of whether bonding surface bouncing is present by comparing the extracted change rate with a set reference change rate.

7. The apparatus for monitoring bonding surface bouncing of claim 6, wherein the reference change rate is reset before the bonding.

8. The apparatus for monitoring bonding surface bouncing of claim 6, further comprising when the generation of bonding surface bouncing is detected in the bouncing detector, a display unit displaying it to the outside.

9. The apparatus for monitoring bonding surface bouncing of claim 6, wherein the sensor is a piezoelectric sensor.

10. An apparatus for monitoring bonding surface bouncing, comprising:
a first sensor measuring a capillary height in real time during bonding;
a second sensor measuring a force feedback value transferred to a bonding surface from the capillary in real time during the bonding; and
a bouncing detector extracting a change rate of a capillary height from the capillary height measured in real time during a bonding performing period and detecting of whether bonding surface bouncing is present by comparing the extracted change rate with a set first reference change rate or extracting a change rate of a feedback value from the feedback value measured in real time during a bonding performing period and detecting of whether bonding surface bouncing is present by comparing the extracted change rate with a set second reference change rate.

11. The apparatus for monitoring bonding surface bouncing of claim 10, wherein the first reference change rate and the second reference change rate are reset before the bonding.

12. The apparatus for monitoring bonding surface bouncing of claim 10, further comprising when the bonding surface bouncing is detected in the bouncing detector, a display unit displaying it to the outside.

13. The apparatus for monitoring bonding surface bouncing of claim 10, wherein the first sensor is an encoder measuring a Z-axis height of the capillary and the second sensor is a piezoelectric sensor.

14. A wire bonding apparatus, comprising:
an apparatus for monitoring bonding surface bouncing including a sensor disposed on an upper portion of a bond head and measuring a capillary height in real time during bonding and a bouncing detector extracting a change rate of a capillary height from the capillary height measured in real time during a bonding performing period and detecting of whether bonding surface bouncing is present by comparing the extracted change rate with a set reference change rate; and
when bonding surface bouncing is detected, a display unit displaying it to the outside.

15. The wire bonding apparatus of claim 14, wherein the reference change rate is reset before the bonding.

16. The wire bonding apparatus of claim 14, further comprising a controller performing controlling to stop the wire bonding when bonding surface bouncing is detected.

17. A wire bonding apparatus, comprising:
an apparatus for monitoring bonding surface bouncing including a sensor measuring a force feedback value transferred to a bonding surface from a capillary in real time during bonding and a bouncing detector extracting a change rate of the feedback value measured in real time during a bonding performing period and detecting of whether bonding surface bouncing is present by comparing the extracted change rate with a set reference change rate; and
when bonding surface bouncing is detected, a display unit displaying it to the outside.

18. The wire bonding apparatus of claim 17, wherein the reference change rate is reset before the bonding.

19. The wire bonding apparatus of claim 17, further comprising a controller performing controlling to stop the wire bonding when bonding surface bouncing is detected.

20. A wire bonding apparatus, comprising:
an apparatus for monitoring bonding surface bouncing including a first sensor measuring a capillary height in real time during bonding, a second sensor measuring a force feedback value transferred to a bonding surface from the capillary in real time during the bonding, and a bouncing detector extracting a change rate of a capillary height from the capillary height measured in real time during a bonding performing period and detecting of whether bonding surface bouncing is present by comparing the extracted change rate with a set first reference change rate or extracting a change rate of a feedback value from the feedback value measured in real time during a bonding performing period and detecting of whether bonding surface bouncing is present by comparing the extracted change rate with a set second reference change rate; and
when bonding surface bouncing is detected, a display unit displaying it to the outside.

21. The wire bonding apparatus of claim 20, wherein the first reference change rate and the second reference change rate are reset before the bonding.

22. The wire bonding apparatus of claim 20, further comprising a controller performing controlling to stop the wire bonding when bonding surface bouncing is detected.

23. A method for monitoring bonding surface bouncing, comprising:
measuring a capillary height in real time during wire bonding;
extracting the capillary height from a bonding start time when the wire is bonded to a bonding surface by lowering the capillary to the bonding surface to pressurization ending time when the bonding surface pressurization of the capillary ends, among the measured capillary heights;
calculating a change rate of the capillary height from the bonding start time to pressurization ending time; and
detecting of whether bonding surface bouncing is present by comparing the change rate of the capillary height with a set reference change rate.

24. The method for monitoring bonding surface bouncing of claim 23, wherein the reference change rate is set in plural, one of them being previously selected before the bonding starts.

25. The method for monitoring bonding surface bouncing of claim 23, further comprising when bonding surface bouncing is detected, displaying the bouncing detection to the outside.

26. The method for monitoring bonding surface bouncing of claim 23, wherein the reference change rate is reset before the bonding starts.

27. The method for monitoring bonding surface bouncing of claim 23, further comprising when bonding surface bouncing is detected, stopping the wire bonding.

28. A method for monitoring bonding surface bouncing, comprising:
measuring a force feedback value transferred to a bonding surface from a capillary during wire bonding in real time;
extracting a feedback value from a bonding start time when the wire is bonded to a bonding surface by lowering the capillary to the bonding surface to pressurization ending time when the bonding surface pressurization of the capillary ends, among the measured feedback values;
calculating a change rate of the feedback value from the bonding start time to pressurization ending time; and
detecting of whether bonding surface bouncing is present by comparing the change rate of the feedback value with a set reference change rate.

29. The method for monitoring bonding surface bouncing of claim 28, wherein the reference change rate is set in plural, one of them being previously selected before the bonding starts.

30. The method for monitoring bonding surface bouncing of claim 28, further comprising when bonding surface bouncing is detected, displaying the bouncing detection to the outside.

31. The method for monitoring bonding surface bouncing of claim 28, wherein the reference change rate is reset before the bonding starts.

32. The method for monitoring bonding surface bouncing of claim 28, further comprising when bonding surface bouncing is detected, stopping the wire bonding.

33. A method for monitoring bonding surface bouncing, comprising:
measuring a capillary height and a force feedback value transferred to a bonding surface from a capillary during wire bonding in real time;
extracting a capillary height and a feedback value, respectively, from a bonding start time when the wire is bonded to a bonding surface by lowering the capillary to the bonding surface to pressurization ending time when the bonding surface pressurization of the capillary ends, among the measured capillary heights;
calculating a change rate of the capillary height and the feedback value, respectively, from the bonding start time to pressurization ending time; and
detecting of whether bonding surface bouncing is present by comparing the change rate of the capillary height with a set first reference change rate and the change rate of the feedback value with a set second reference change rate.

34. The method for monitoring bonding surface bouncing of claim 33, further comprising resetting the first reference change rate and the second reference change rate before the wire bonding starts.

35. The method for monitoring bonding surface bouncing of claim 33, wherein the detecting of whether bonding surface bouncing is present by comparing the change rate of the capillary height with a set first reference change rate and the change rate of the feedback value with a set second reference change rate determines that bonding surface bouncing occurs if it corresponds to any one of the cases in which the change rate of the extracted capillary height exceeds the set first reference change rate or the change rate of the feedback value exceeds the set second reference change rate.

36. The method for monitoring bonding surface bouncing of claim 33, further comprising when bonding surface bouncing is detected, displaying the bounding detection by a lamp or an alarm.

37. A recording medium recorded with a program monitoring bonding surface bouncing in real time of claim 23 and readable with electronic devices.

38. A recording medium recorded with a program monitoring bonding surface bouncing in real time of claim 28 and readable with electronic devices.

39. A recording medium recorded with a program monitoring bonding surface bouncing in real time of claim 33 and readable with electronic devices.
